(19) United States
(12) Patent Application Publication
(10) Pub. No.: US 2025/0142442 A1
(43) Pub. Date: May 1, 2025

(54) USER EQUIPMENT HANDOVER IN RADIO CELLS

(71) Applicant: CORNING RESEARCH & DEVELOPMENT CORPORATION, Corning, NY (US)

(72) Inventors: Syed Noman Ahmad, San Jose, CA (US); Cherayi Kunjunny Mohanakumar, Milpitas, CA (US); Pushkar Upadhyay, Fremont, CA (US); Yi Yuan, San Jose, CA (US)

(21) Appl. No.: 18/386,041

(22) Filed: Nov. 1, 2023

(51) Int. Cl. H04W 36/38; H04W 36/30

(52) U.S. Cl. CPC H04W 36/38; H04W 36/30

(57) ABSTRACT

Systems and methods for user handover in Fifth Generation-New Radio (5G-NR) are disclosed. In one aspect, in a wireless communication system (WCS) that has a hybrid Fourth generation (4G) core subsystem and one or more 5G-NR radio access network (RAN) subsystems, user equipment handover may be controlled by a 4G master evolved NodeB (MeNB). To assist the MeNB in this process, user equipment (UE) may provide B1 reports when signal strength from proximate radio cells exceeds a threshold or falls below a threshold. Based on these B1 reports, a control circuit within the MeNB may select a cell and initiate a handover. Moving the handover decision to the MeNB in such a hybrid WCS may improve the user experience by providing more reliable connections between the user equipment and the most efficient cell.

### BACKGROUND

The technology of the disclosure relates generally to handover for user equipment (UE) as the user equipment moves within Fifth Generation-New Radio (5G-NR) cells.

Computing devices abound in modern society, and more particularly, mobile communication devices have become increasingly common. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences. With the advent of the myriad functions available to such devices, there has been increased pressure to find ways to improve the bandwidth available to send and receive data to and from mobile communication devices. This pressure has resulted in evolving cellular standards. In particular, the cellular world is moving or has moved from Fourth Generation (4G) networks to Fifth Generation-New Radio (5G-NR) networks. However, as it is expensive to replace entire networks, in many cases, network operators may have created a hybrid network that uses some 4G technology and some 5G technology. Such a hybrid approach provides room for innovation.

### SUMMARY

Aspects disclosed in the detailed description include systems and methods for user handover in Fifth Generation-New Radio (5G-NR) cells. More particularly, in a wireless communication system (WCS) that has a hybrid fourth generation (4G) core subsystem and one or more 5G-NR radio access network (RAN) subsystems, user equipment handover may be controlled by a 4G master evolved NodeB (MeNB). To assist the MeNB in this process, user equipment (UE) may provide B1 reports when signal strength from proximate radio cells exceeds a threshold or falls below a threshold. Based on these B1 reports, a control circuit within the MeNB may select a cell and initiate a handover. Moving the handover decision to the MeNB in such a hybrid WCS may improve the user experience by providing more reliable connections between the user equipment and the most efficient cell.

In this regard, in one aspect, an enhanced NodeB (eNB) is disclosed. The eNB includes a first interface configured to communicate with user equipment and a control circuit coupled to the first interface. The control circuit is configured to receive B1 reports from UE, determine that a handover between cells is appropriate based on the B1 reports, and initiate the handover of the user equipment from a first cell to a second cell.

In another aspect, a method of controlling handovers is disclosed. The method includes, at an eNB, receiving B1 reports from UE, and determining, at the eNB, that a handover between cells is appropriate based on the B1 reports. The method further includes initiating the handover of the UE from a first cell to a second cell.

### BRIEF DESCRIPTION OF THE DRAWINGS

FIG. 1A is a block diagram of a Fourth generation (4G) wireless communication system (WCS);

FIG. 1B is a block diagram of a hybrid 4G-Fifth Generation (5G) WCS that may be used with exemplary aspects of the user handover of the present disclosure;

FIG. 2 is a stylized diagram of elements within the hybrid 4G-5G WCS of FIG. 1B with additional details provided about the elements that may implement aspects of the user handover of the present disclosure;

FIG. 3 is a block diagram of an exemplary master evolved NodeB (MeNB) that may control aspects of the user handover of the present disclosure;

FIG. 4 is a flowchart illustrating an exemplary process for controlling user handover according to aspects of the present disclosure;

FIG. 5 is a signal flow diagram illustrating how user handover may be effectuated when an anchor cell and a destination cell are controlled by different NodeBs;

FIG. 6 is a signal flow diagram illustrating how user handover may be effectuated when an anchor cell and a destination cell are controlled by the same NodeB;

FIG. 7 is a schematic diagram of an exemplary wireless communications system (WCS), such as a distributed communications system (DCS), configured to distribute communications services to remote coverage areas;

FIGS. 8A and 8B are examples of Open-standard RANs (O-RANs);

FIG. 9 is an exemplary RAN system that includes multiple O-RANs that are configured to support different service providers and that are each configured to directly interface with a shared modified Open-standard remote unit (O-RU);

FIG. 10 is an exemplary RAN system that includes multiple RANs (e.g., O-RANs) implemented according to a RAN standard (e.g., O-RAN standard), wherein each RAN is configured to support a different service provider;

FIG. 11 is a schematic diagram of the exemplary division of components and communications layers between devices in an O-RAN in the RAN system in FIG. 10;

FIG. 12 is a schematic diagram of an exemplary RAN system, including, but not limited to the RAN systems disclosed herein;

FIG. 13 is a partial schematic cut-away diagram of an exemplary building infrastructure that includes a RAN system, including, but not limited to the RAN systems disclosed herein;

FIG. 14 is a schematic diagram of an exemplary mobile telecommunications environment that can include a RAN system, including, but not limited to the RAN systems disclosed herein; and

FIG. 15 is a block diagram of a processor-based system that may be present within one or more elements of the WCS described above.

### DETAILED DESCRIPTION

Aspects disclosed in the detailed description include systems and methods for user handover in Fifth Generation-New Radio (5G-NR) cells. More particularly, in a wireless communication system (WCS) that has a hybrid fourth generation (4G) core subsystem and one or more 5G-NR radio access network (RAN) subsystems, user equipment handover may be controlled by a 4G master evolved NodeB (MeNB). To assist the MeNB in this process, user equipment (UE) may provide B1 reports when signal strength from proximate radio cells exceeds a threshold or falls below a threshold. Based on these B1 reports, a control circuit within the MeNB may select a cell and initiate a handover. Moving the handover decision to the MeNB in such a hybrid WCS may improve the user experience by providing more reliable connections between the user equipment and the most efficient cell.

A discussion of wireless communication standards almost always relies on an abundance of acronyms. These acronyms may be particularly confusing to the reader when there are nested acronyms. To assist the reader, a list of the more complex nested acronyms and their meanings is provided.

UMTS stands for Universal Mobile Telecommunications System.

UTRAN stands for Universal Terrestrial Radio Access Network or UMTS Terrestrial Radio Access Network.

E-UTRAN stands for Evolved-UTRAN.

ENDC stands for E-UTRAN New Radio-Dual Connectivity.

While there are numerous other acronyms, the introduction of such is not as disruptive as these nested acronyms, and discussion is deferred until relevant below.

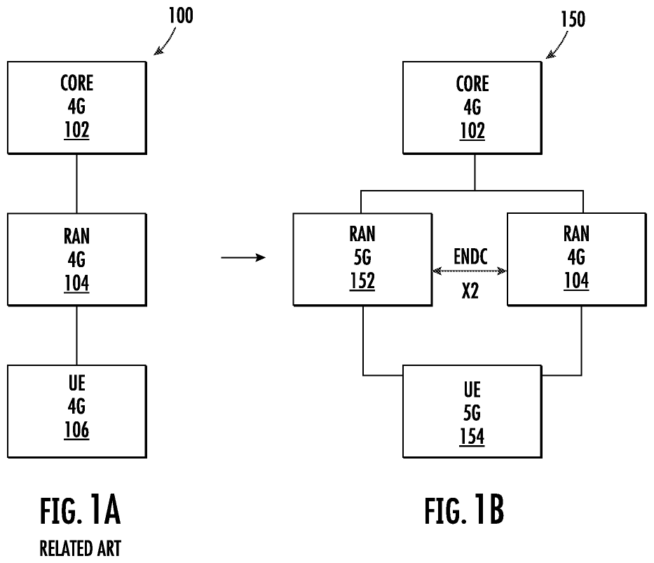

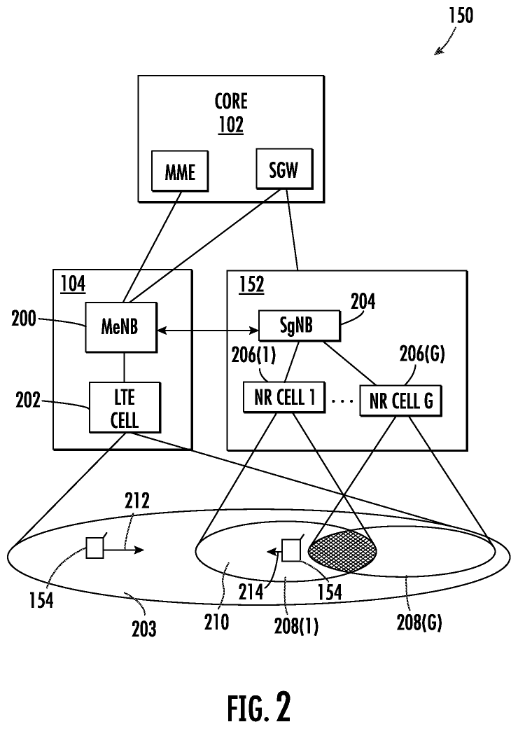

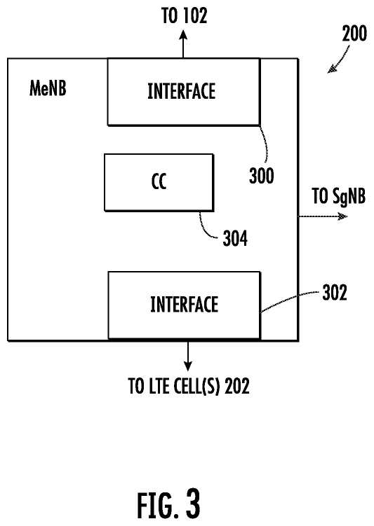

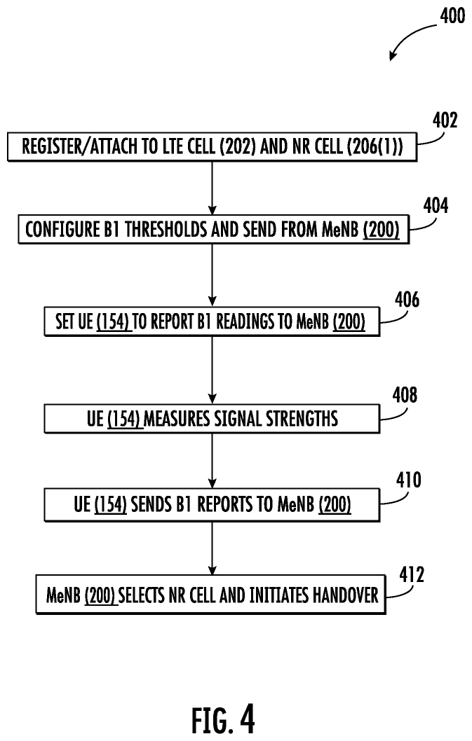

Before addressing aspects of the present disclosure, a brief discussion of how WCSs have evolved is provided with reference to FIGS. 1A and 1B. Based on the evolution and existence of a hybrid WCS, as illustrated in FIG. 1B, room for innovation in how handover is handled has been identified. Additional details about elements of the hybrid WCS are provided with reference to FIGS. 2 and 3. A discussion of specific aspects of the user handover begins below with reference to FIG. 4.

In this regard, FIG. 1A is a block diagram of a conventional wireless communication system 100 such as may have existed in the mid-2010s. As such, the WCS 100 may have included a core subsystem 102 and a radio access network subsystem 104 that served to provide wireless communication for user equipment (UE) 106. Given the timing of the existence of WCS 100, each of the subsystems 102 and 104 may have operated using Fourth generation (4G) wireless protocols. Likewise, to operate with the subsystems 102 and 104, the UE 106 may also have operated using 4G wireless protocols.

Beginning around 2018 or 2019, 5G-NR started to be deployed. To extend the lifecycle of large 4G capital investments, some providers only replaced the RAN subsystem with a 5G RAN subsystem, or even just added the 5G RAN subsystem to the existing system, as better illustrated in FIG. 1B. More specifically, WCS 150 may include a 4G core subsystem 102, a 4G RAN 104, and a 5G RAN subsystem 152. The subsystems 104 and 152 may communicate over an ENDC X2 interface. The UE 154 may use 4G or 5G protocols (or both using E-UTRAN). Using ENDC allows the UE to access both 5G and 4G networks at the same time, which allows carriers to tap into the benefits of both network technologies simultaneously.

It should be appreciated that the WCS 150 may include a MeNB 200, as illustrated in FIG. 2. In particular, the MeNB 200 may be in the 4G RAN 104 and an LTE cell 202 having a service area 203. While only one LTE cell 202 is shown, it should be appreciated that in a hybrid WCS 150, multiple LTE cells 202 may be present. Further, the RAN subsystem 152 may include a SgNB 204 that operates with a plurality of new radio (NR) cells 206(1)-206(G), each with a respective service area 208(1)-208(G), which may include one or more areas of overlap 210. In areas of overlap 210, a UE 154 may be able to send and receive signals to and from multiple ones of the cells 202, 206(1)-206(G). Further, as the UE 154 moves (generally arrow 212 or 214), the signal strength from a given one of the cells 206(1)-206(G) may change. Aspects of the present disclosure facilitate the selection of an optimal one of the cells 206(1)-206(G) to which the UE 154 may latch.

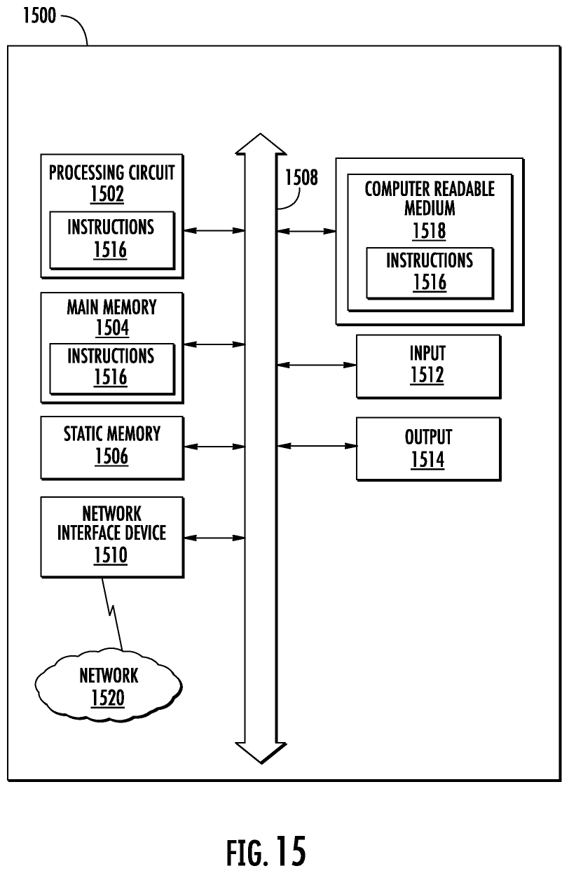

Before addressing the solutions offered by the present disclosure, a bit more detail is offered for the MeNB 200 in FIG. 3. Specifically, the MeNB 200 may include a first interface 300 configured to communicate with other 4G elements in the core subsystem 102 (not shown in FIG. 3) and a second interface 302 configured to communicate with the LTE cells 202 and/or directly with UE 154. Additionally, the MeNB 200 may communicate with an SgNB. Operation of the MeNB 200 may be controlled by a control circuit 304 which may include a processor and memory that stores operating instructions therein (see FIG. 15 for additional details).

As noted above, UE 154 may be connected to both the 4G core subsystem 102 and the RAN subsystem 152. More specifically, the UE 154 may be connected to two NodeBs, including the MeNB 200 and a secondary gNB (SgNB), which act on different carriers and are connected by an X2 interface defined in the 3^{rd} Generation Partnership Project (3GPP) standards. The MeNB 200 and the SgNB exchange messages through the X2AP protocol, and the MeNB 200 is responsible for signaling and instructions to add 5G carriers if necessary.

In the past, when UE 154 moves out of coverage of a currently serving cell within the cells 206(1)-206(G), the SgNB detects the deteriorating radio link quality and triggers the UE 154 to handover to a better cell in the cells 206(1)-206(G) before radio link failure occurs. As noted, in the past, the decision-making for this handover was in the SgNB, and the MeNB would support exchanging radio resource control (RRC) transfer messages to and from the SgNB. While this approach is functional, reliance on the SgNB limits design options when deploying the WCS 150.

Exemplary aspects of the present disclosure provide the option to move the handover decision-making to the MeNB 200. In particular, aspects of the present disclosure cause the UE 154 to provide Event B1 NR reports to be provided to the MeNB 200, which determines when a handover should be triggered. Responsive to the determination, the MeNB 200 uses existing X2AP protocol signaling to effectuate the handover. Providing an alternative to the SgNB decision-making provides more options when deploying the WCS 150. The B1 NR report is defined by the 3GPP to be a report that identifies when the signal strength of a cell rises above a threshold or falls below a threshold. This signal strength is measured at the UE 154 and may rely on the received signal strength indicator (RSSI), reference signal received power (RSRP), or the like.

A flowchart of the process 400 for initiating handover at the MeNB 200 is provided with reference to FIG. 4. In this regard, the process begins with UE 154 registering or attaching to an LTE cell 202 and a NR cell 206(1) (block 402). The control circuit 304 configures B1 thresholds and sends the thresholds from the MeNB 200 (block 404) to the UE 154. The control circuit 304 further sets the UE 154 to report B1 readings to the MeNB 200 (block 406). During operation, the UE 154 measures signal strengths (block 408) and sends B1 reports to the MeNB 200 (block 410) based on when thresholds are exceeded or dropped below. The control circuit 304 within the MeNB 200 selects an NR cell and initiates a handover (block 412) when the control circuit 304 determines that the UE 154 may more optimally be served by a different cell. This determination may be based on absolute signal strength differences (i.e., select the stronger signal), an amount better between signal strength differences (i.e., the proposed new cell is a certain amount better than the current cell), the difference between sign a perceived direction of travel for the UE 154, a load management metric, or the like.

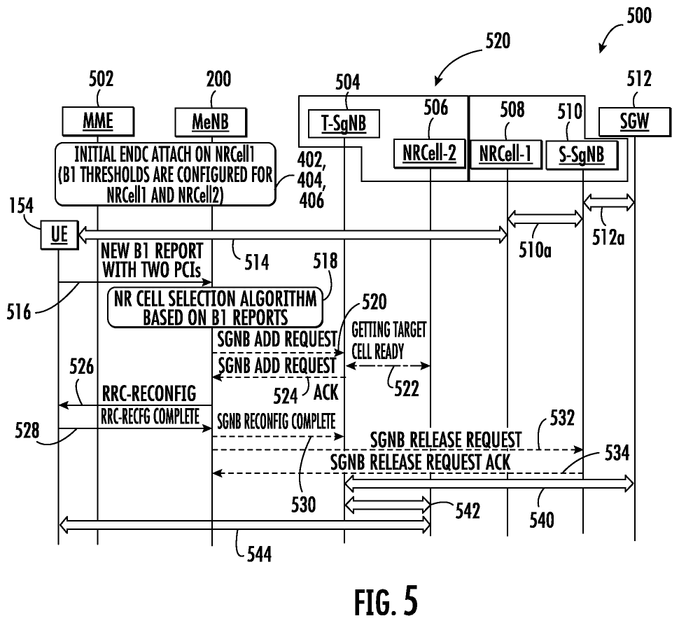

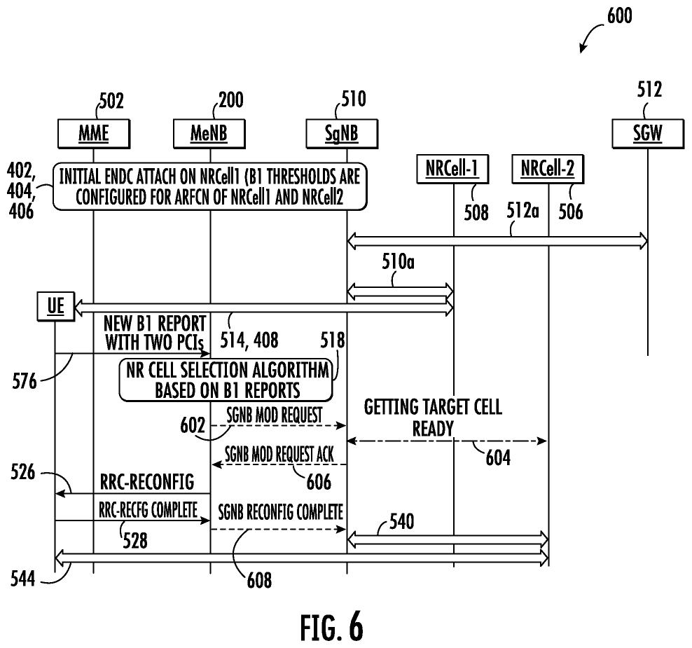

Exemplary signal flows are presented relative to the handover in FIGS. 5 and 6. The signal flow 500 of FIG. 5 illustrates the situation where the target cell is associated with a target SgNB different than the source SgNB for the originating cell. In contrast, the signal flow 600 of FIG. 6 illustrates the situation where the target cell and the originating cell are both associated with the source SgNB.

In this regard, the signal flow 500 may pass between UE 154, mobility management entity (MME) 502, MeNB 200, a target SgNB 504, a target cell 506, an originating cell 508, a source SgNB 510, and a serving gateway (SGW) 512. The originating cell 508 communicates with the source SgNB 510 (signal 510a), and the source SgNB 510 communicates with the SGW 512 (signal 512a) to pass communications to and from remote sources (e.g., the public switched telephone network (PSTN), the internet, or the like). The process 400 starts the signal flows where the control circuit 304 configures B1 parameters, including thresholds and hysteresis, along with a report amount and a report interval (i.e., what is included in B1 and how frequently the UE 154 makes the B1 reports) (i.e., blocks 402, 404, 406). The UE 154 communicates with the originating cell 508 (flow 514) during normal operation. Signal strength measurements are made based on this communication (i.e., block 408). At some point, the UE 154 sends a B1 report with at least two physical cell identifiers (PCI) identifying the originating cell 508 and the target cell 506 (signal 516, block 410). Note that PCI may be used to differentiate between cells that operate on the same frequency; otherwise, if the frequencies are used uniquely, then the identification of the frequency may be sufficient to identify the cell.

Based on the B1 reports, the MeNB 200 and, specifically, the control circuit 304 may determine a new NR cell for the UE 154, block 518/block 412. That is, the control circuit 304 may compare the RSRPs in the report with that of the originating cell 508. If the neighbor's RSRP is higher than the originating cell 508, the switch is determined. Having made the determination, the MeNB 200 sends an SgNB add request to the target SgNB 504 (signal 520). The target SgNB 504 sends a signal to the target cell 506 with instructions to get the target cell 506 ready (signal 522). The target SgNB 504 then responds to the MeNB 200 with an ACK (signal 524). The MeNB 200 then sends an RRC reconfiguration signal to the UE 154 (signal 526), which responds with a reconfiguration complete signal (signal 528). The MeNB 200 then sends an SgNB reconfiguration complete signal (signal 530) to the target SgNB 504.

The MeNB 200 then sends an SGNB release request to the originating SgNB 510 (signal 532), which responds with an ACK (signal 534). After signal 534, data may flow to the target cell 506 while data from the SGW 512 passes to the target SgNB 504 (signal 540) and from the target SgNB 504 to the target cell 506 (signal 542). Likewise, data may from the UE 154 to the target cell 506 (signal 544).

Similarly, signal flow 600 has many of the same elements and begins much the same. However, instead of the add request signal 520, the signal flow 600 diverges when the MeNB 200 sends an SGNB modification request (signal 602) to the SgNB 510. The SgNB 510 signals the target cell 506 to get ready (signal 604) and sends an ACK to the MeNB 200 (signal 606). The remaining portions of the signal flow 600 are the same as the signal flow 500, except the reconfiguration complete signal 608 replaces the signal 530.

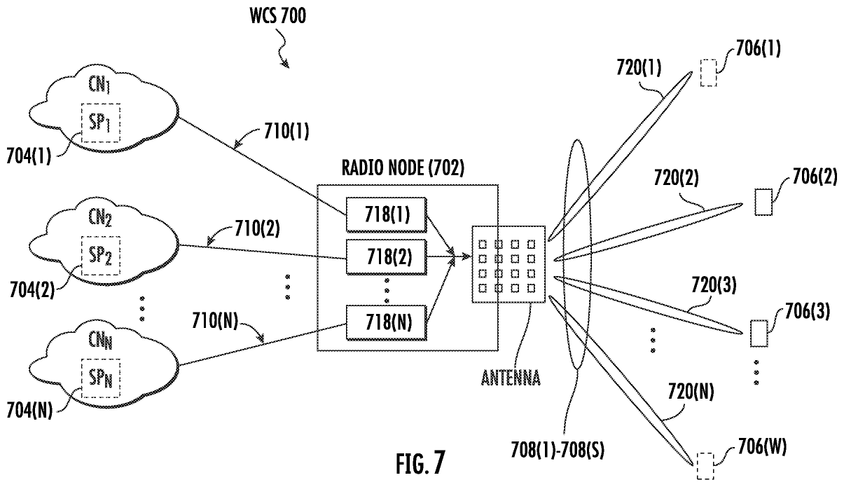

While the above discussion provides the specifics of the present disclosure, FIGS. 7-15 provide additional background information about a WCS and the related subsystems, which may be helpful in appreciating the scope and context of the particulars discussed above.

In this regard, FIG. 7 is an example of a WCS 700 that includes a radio node 702 configured to support one or more service providers 704(1)-704(N) as signal sources (also known as “carriers” or “service operators”—e.g., mobile network operators (MNOs)) and wireless client devices 706(1)-706(W). For example, the radio node 702 may be a base station (eNodeB such as MeNB 200, TgNB 504, SgNB 510, or the like) that includes modem functionality and is configured to distribute communications signal streams 708(1)-708(S) to the wireless client devices 706(1)-706(W) based on communications signals 710(1)-710(N) received from the service providers 704(1)-704(N). The communications signal streams 708(1)-708(S) of each respective service provider 704(1)-704(N) in their different spectrums are radiated through an antenna 712 to the wireless client devices 706(1)-706(W) in a communication range of the antenna 712. For example, the antenna 712 may be an antenna array. As another example, the radio node 702 in the WCS 700 in FIG. 7 can be a small cell radio access node (“small cell”) that is configured to support the multiple service providers 704(1)-704(N) by distributing the communications signal streams 708(1)-708(S) for the multiple service providers 704(1)-704(N) based on respective communications signals 710(1)-710(N) received from a respective evolved packet core (EPC) network CN₁-CN_{N} of the service providers 704(1)-704(N) through interface connections. The radio node 702 includes radio circuits 718(1)-718(N) for each service provider 704(1)-704(N) that are configured to create multiple simultaneous RF beams (“beams”) 120(1)-120(N) for the communications signal streams 708(1)-708(S) to serve multiple wireless client devices 706(1)-706(W). For example, the multiple RF beams 120(1)-120(N) may support multiple-input, multiple-output (MIMO) communications.

The radio node 702 of the WCS 100 in FIG. 7 may be configured to support service providers 704(1)-704(N) that have a different frequency spectrum and do not share the spectrum. Thus, in this instance, the communications signals 710(1)-710(N) from the different service providers 704(1)-704(N) do not interfere with each other, even if transmitted by the radio node 702 at the same time. The radio node 702 may also be configured as a shared spectrum communications system where the multiple service providers 704(1)-704(N) have a shared spectrum. In this regard, the capacity supported by the radio node 702 for the shared spectrum is split (i.e., shared) between the multiple service providers 704(1)-704(N) for providing services to the subscribers.

The radio node 702 in FIG. 7 can also be coupled to a distributed communications system (DCS), such as a distributed antenna system (DAS), such that the radio circuits 718(1)-718(N) remotely distribute the communications signals 710(1)-710(N) of the multiple service providers 704(1)-704(N) to remote units. The remote units can each include an antenna array that includes tens or even hundreds of antennas for concurrently radiating the communications signals 710(1)-710(N) to subscribers using spatial multiplexing. Herein, the spatial multiplexing is a scheme that takes advantage of the differences in RF channels between transmitting and receiving antennas to provide multiple independent streams between the transmitting and receiving antennas, thus increasing throughput by sending data over parallel streams. Accordingly, the remote units can be said to radiate the communications signals 710(1)-710(N) to subscribers based on a massive multiple-input multiple-output (M-MIMO) scheme.

As noted above, the WCS 700 may be configured to operate as a 5G and/or a 5G-NR communications system and, more particularly, as a hybrid 4G/5G system. In this regard, the radio node 702 can function as a 5G or 5G-NR base station (a.k.a. eNodeB, such as MeNB 200) to service the wireless client devices 706(1)-706(W). Notably, the 5G or 5G-NR wireless communications system may be implemented based on a millimeter-wave (mmWave) spectrum that can make the communications signals 710(1)-710(N) more susceptible to propagation loss and/or interference. As such, it is desirable to radiate the RF beams 720(1)-720(N) based on a desirable number of RF beams to help mitigate signal propagation loss and/or interference.

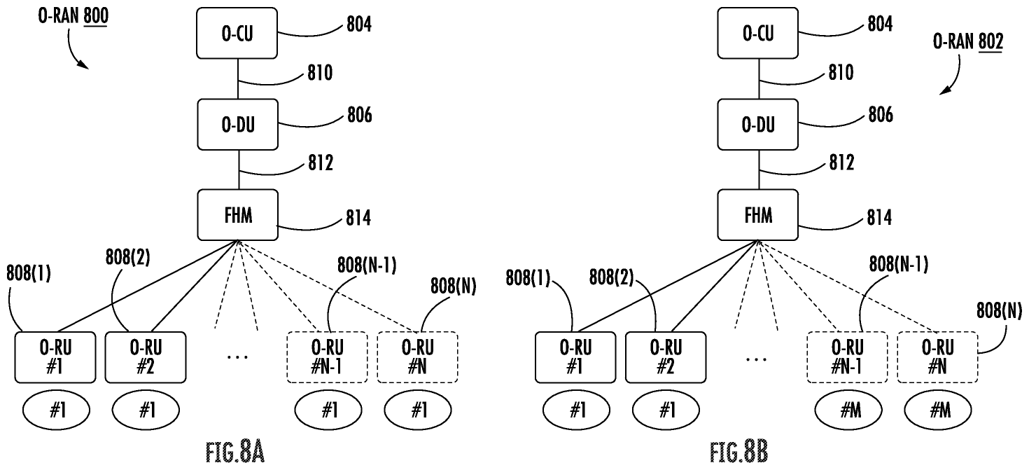

Open-RAN (O-RAN) is a set of specifications that specifies multiple options for functional divisions of a cellular base station between physical units, and it also specifies the interface between these units. An example for a possible division specified by O-RAN is in the O-RANs 800, 802 shown in FIGS. 8A and 8B, respectively. In the O-RANs 800, 802, the functionality of the base station (e.g., gNB, as called in the context of 5G) is divided into three functional units of an O-RAN central unit (O-CU) 804, an O-RAN distribution unit (O-DU) 806, and one or more O-RAN remote units (O-RUs) 808(1)-808(N). These components may run on different hardware platforms and reside at different locations. The O-RUs 808(1)-808(N) include the lowest layers of the base station, and it is the entity that wirelessly transmits and receives signals to user devices. The O-CU 804 includes the highest layers of the base station and is coupled to a “core network” of the cellular service provider. The O-DU 806 includes the middle layers of the base station to provide support for a single cellular service provider (also known as operator or carrier). An F1 interface 810 is connected between the O-CU 804 and the O-DU 806. An eCPRI/O-RAN fronthaul interface 812 connects the O-DU 806 and an O-RU 808. The F1 interface 810 and eCPRI/O-RAN fronthaul interface 812 use Ethernet protocol for conveying the data in this example. Therefore, Ethernet switches (not shown in FIGS. 8A and 8B) may exist between the O-CU 804 and the O-DU 806 and between the O-DU 806 and the O-RU 808.

Each O-DU 806 can also be coupled to a single or to a cluster of O-RUs 808(1)-808(N) that serve signals of the one or more “cells” of the O-DU 806. A “cell” in this context is a set of signals intended to serve subscriber units (e.g., cellular devices) in a certain area. Multiple O-Rus 808(1)-808(N) are supported in the O-RAN by what is referred to as a “Shared-Cell.” Shared Cell is realized by a front-haul multiplexer (FHM) 814, placed between the O-DU 806 and the O-RUs 808(1)-808(N). The FHM 814 de-multiplexes signals from the O-DU 806 to the plurality of O-RUs 808(1)-808(N) and multiplexes signals from the plurality of O-RUs 808(1)-808(N) to O-DU 806. The FHM 814 can be considered as an O-RU with fronthaul support and additional copy-and-combine function but lacks the RF front-end capability. The O-RAN 800 in FIG. 8A shows the O-RUs 808(1)-808(N) supporting the same cell (#1). The O-RAN 802 in FIG. 8B shows each O-RU 808(1)-808(N) supporting the different cell (#1 . . . #M). In each case of the O-RANs 800, 802 in FIGS. 8A and 8B, and the O-DU 806 provide support for a single cellular service provider to provide cell services to the plurality of O-RUs 808(1)-808(N).

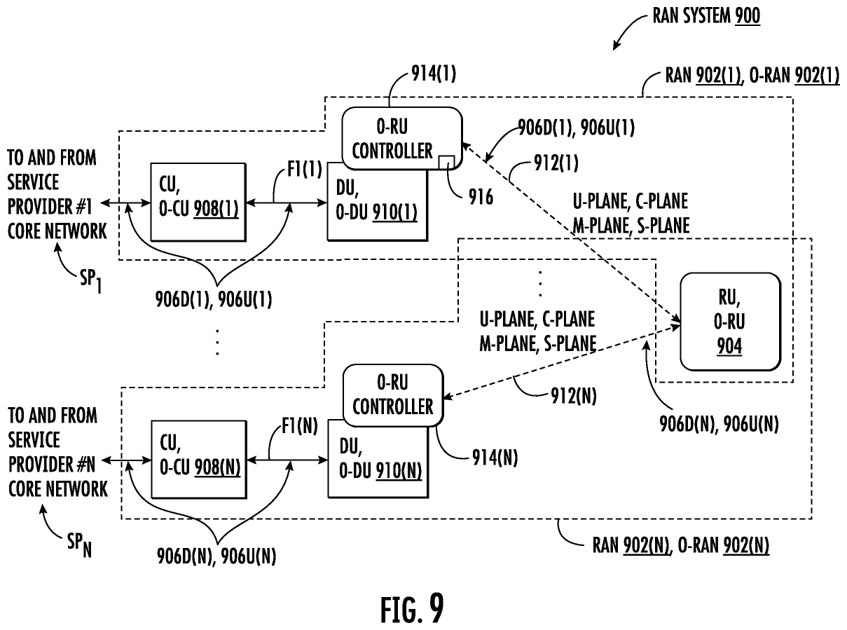

Again, while perhaps not central to the present disclosure, an exemplary RAN system that includes multiple higher-layer RAN entities configured to a shared RU is described with regard to FIG. 9 below.

In this regard, FIG. 9 is an exemplary RAN system 900 that includes multiple RANs 902(1)-902(N), each configured to support different service providers that are each configured to directly interface with a shared modified RU 904, wherein ‘N’ can be any positive whole number to signify the number of RANs. For example, the RANs 902(1)-902(N) may be O-RANs that are compatible with the Open-RAN standard set forth by the O-RAN Alliance, found at https://www.o-ran.org/. O-RAN is a set of specifications that specifies multiple options for functional divisions of a cellular base station between physical units, and it also specifies the interface between these units. As an example, RANs 902(1)-902(N) can be small cell RANs that are configured to support multiple service providers SP₁-SP_{N} by distributing downlink communications signals 906D(1)-906D(N) (e.g., communication channels) for the multiple service providers SP₁-SP_{N}. The RANs 902(1)-902(N) both include a shared RU 904 that is configured to support one or more service providers SP₁-SP_{N} as signal sources (also known as “carriers” or “service operators”—e.g., a mobile network operator (MNO). In this manner, the multiple RANs 902(1)-902(N) can share access to the RU 904 as opposed to each RAN 902(1)-902(N) having to include its own dedicated RUs. Providing for the ability of the RU 904 to be shared between the multiple RANs 902(1)-902(N) may be efficient in terms of cost and area, as it may be desired to provide antenna coverage for the multiple service providers SP₁-SP_{N} in the same physical location and area. The shared RU 904 is configured to wirelessly distribute the received downlink communications signals 906D(1)-906D(N) (e.g., in the form of communication channels) received from the respective service providers SP₁-SP_{N}, distributed by respective O-RAN Central Units (O-CUs) 908(1)-908(N) and O-RAN Distribution Units (O-DUs) 910(1)-910(N), to user client devices in the reception range of the RU 904. The shared RU 904 can include the lowest layers of a base station, and it is the entity that wirelessly transmits and receives signals to user devices. The O-CUs 908(1)-908(N) can include the highest layers of the base station and can be configured to be coupled to a “core network” of a respective cellular service provider SP₁-SP_{N} (also known as operator or carrier). The DUs 910(1)-910(N) can include middle layers of the base station to provide support for a respective cellular service provider SP₁-SP_{N}.

The downlink communications signals 906D(1)-906D(N) may be received from a base station (e.g., an eNB or gNB) or respective evolved packet cores (EPC) network of the respective service providers SP₁-SP_{N} through interface connections. Small cells can support one or more service providers in different channels within a frequency band to avoid interference and reduced signal quality as a result. The shared RU 904 is also configured to receive uplink communications signals 906U(1)-906U(N) (e.g., in the form of uplink communication channels) wirelessly received from user devices. The shared RU 904 is configured to distribute such received uplink communications signals 906U(1)-906U(N) to the respective service providers SP₁-SP_{N} through the respective O-DUs 910(1)-910(N) and O-CUs 908(1)-908(N). Secure communications tunnels are formed between the RU 904 and the respective service providers SP₁-SP_{N}. Thus, in this example, the RANs 902(1)-902(N) essentially appear as a single node (e.g., eNB in 4G or gNB in 5G) to the respective service providers SP₁-SP_{N}.

As discussed above, the RAN 902(1)-902(N) in the RAN system 900 may be O-RANs that are compatible with the O-RAN standard and thus are referred to as O-RANs 902(1)-902(N). In this regard, in the O-RANs 902(1)-902(N) configured as O-RANs, the functionality of the base stations (e.g., gNB, as called in the context of 5G) of the respective O-RANs 902(1)-902(N) is divided into three (9) functional units of an O-RAN central unit (O-CU) 908(1)-908(N), an O-RAN distribution unit (O-DU) 910(1)-910(N), and the shared RU 904 as an O-RAN RU (O-RU) 904. These components may run on different hardware platforms and reside at different locations. The shared O-RU 904 includes the lowest layers of the base station, and it is the entity that wirelessly transmits and receives signals to user devices. The O-CUs 908(1)-908(N) include the highest layers of the base station and are coupled to a “core network” of the cellular service provider. The O-DUs 910(1)-910(N) include the middle layers of the base station to provide support for a single cellular service provider (also known as operator or carrier). F1 interfaces F1(1)-F1(N) are connected between the respective O-CUs 908(1)-908(N) and the O-DUs 910(1)-910(N). A respective eCPRI/O-RAN fronthaul interface 912(1)-912(N) connects the respective O-DUs 910(1)-910(N) to the shared O-RU 904 that serve signals of the “cells” of the O-DUs 910(1)-910(N). A “cell” in this context is a set of signals of a given service provider SP₁-SP_{N} intended to serve subscriber units (e.g., cellular devices) in a certain area. The F1 interfaces F1(1)-F1(N) and eCPRI/O-RAN fronthaul interfaces 912(1)-912(N) use Ethernet protocol for conveying the data in this example. Therefore, Ethernet switches (not shown) may exist between the respective O-CUs 908(1)-908(N) and the O-DUs 910(1)-910(N) and between the respective O-DUs 910(1)-910(N) and the shared O-RU 904.

In the RAN system 900 in FIG. 9, the fronthaul of the O-RANs 902(1)-902(N) consists of four planes: User Plane (U-Plane), Control Plane (C-Plane), Management Plane (M-Plane) and Synchronization Plane (S-Plane) according to the O-RAN standards. The U-Plane carries O-RAN conforming user data in the communications signals 908D(1)-908D(N), 908U(1)-908U(N) as I-Q samples between the respective O-DUs 910(1)-910(N) and the shared O-RU 904. The C-Plane is used by the O-DUs 910(1)-910(N) to dynamically provide the shared O-RU 904 with information about the structure of downlink user data plane data to be received from O-DUs 910(1)-910(N) (and to be sent towards the user equipment by the O-RU 904) and the structure of uplink user data plane to be sent to the O-DUs 910(1)-910(N) (as received from the user equipment). The M-Plane is used to provide O-RU 904 with software updated and all configuration information to properly operate the O-RAN Fronthaul, the air interface of the O-RU 904, and other O-RU 904 operations. The M-Plane is also used to convey alarms, key performance indicator (KPI) logs, and other O-RU 904 originating information. The M-Plane is terminated on one end at the O-RU 904 and on the other end of a respective O-RU controller 914(1)-914(N) in each respective O-RAN 902(1)-902(N). The O-RU controller 914(1)-914(N) can be a controller circuit (e.g., a microcontroller, a microprocessor) that can execute software and may be collocated with the function of the O-DUs 910(1)-910(N) or be a separate function from the O-DUs 910(1)-910(N). The S-Plane provides the O-RU 904 with time reference, typically using PTP 1588 protocol. The S-Plane is terminated at the O-RU 904 on one end, and on the other end, it is terminated at a timing source 916 (e.g., a clock circuit). The timing source may be collocated with an O-DU 910(1)-910(N) or be a separate entity from an O-DU 910(1)-910(N), such as a PTP Grand Master (GM) or a timing-aware Ethernet Switch typically configured as a boundary clock or transparent clock.

In a standard O-RAN configuration, each O-RU is not shared like shown in the RAN system 900 in FIG. 9, but rather is coupled to a single O-RU Controller that is fully responsible for managing, configuring, and monitoring a respective O-RU. This model works well when the O-RU is used in a single operator (i.e., service provider) arrangement. However, if the O-RU is desired to be operated in a service provider neutral arrangement (i.e., a single O-RU is shared and utilized for multiple service operators simultaneously like the O-RU 904 in the RAN system 900 in FIG. 9), each service operator would need to have its own M-Plane towards the O-RU 904. In this scenario, using the RAN system 900 in FIG. 9 as an example, the O-RU 904 would need to be customized in design to support multiple M-Plane terminations. The shared O-RU 904 would also need to be designed and customized to handle all complexities related to coordinating and managing these independent M-Planes.

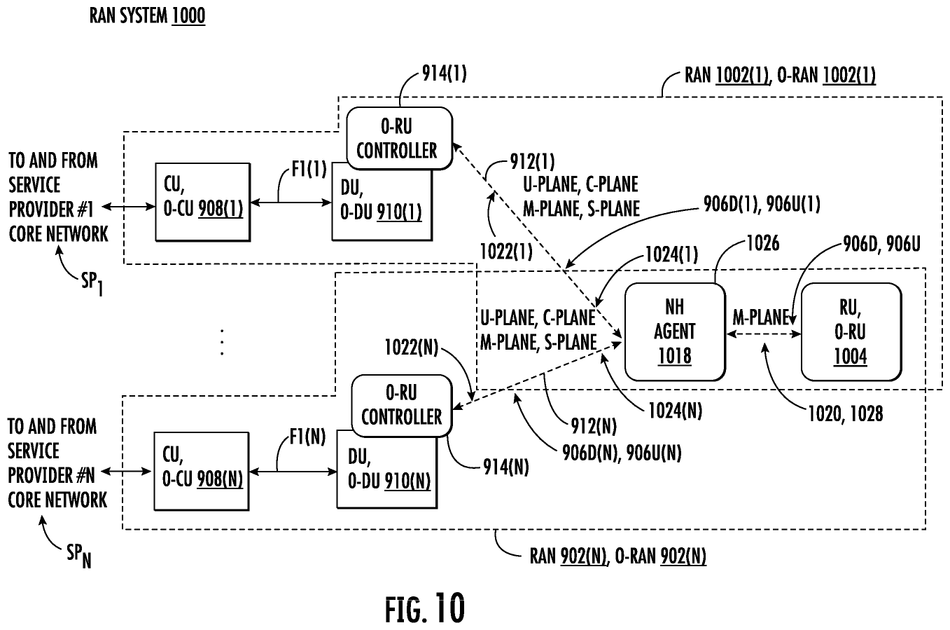

In this regard, FIG. 10 is an exemplary RAN system 1000 that includes multiple RANs 1002(1)-1002(N), each configured to interface with a shared RU 1004 through an intermediary neutral host agent device 1018 that has a transparent interface to the respective DUs 910(1)-910(N) in the RANs 1002(1)-1002(N). As discussed in more detail below, the neutral host agent device 1018 provides for the ability of DUs 910(1)-910(N) of the respective RANs 1002(1)-1002(N) and the shared RU 1004 to be able to communicate information and signals to each other transparently according to a RAN standard (e.g., the O-RAN standard) as if the shared RU 1004 was dedicated to one of the RANs 1002(1)-1002(N) (i.e., not shared between multiple RANs 1002(1)-1002(N)). The neutral host agent device 1018 can be a circuit, such as a controller or a processor, that executes software to perform designated tasks. As another example, the neutral host agent device 1018 can be realized by software executed in another existing controller or processor that is included in the RAN system 1000, such as an O-RU controller 914(1)-914(N) in a respective DU 910(1)-910(N). As shown in FIG. 10, the neutral host agent device 1018 is communicatively coupled between the DUs 910(1)-910(N) of the multiple RAN 1002(1)-1002(N) and their shared RU 1004. The neutral host agent device 1018 is configured to support the coordination and management of communications (e.g., in communications planes) between the multiple RANs 1002(1)-1002(N) and the shared RU 1004 that is otherwise not supported by a RAN standard. In this manner, the shared RU 1004 does not have to be designed and implemented in a customized fashion with functionality not included in the RAN standard implemented by the RAN system 1000 to handle and coordinate communications for multiple RANs 402(1)-402(N) to user devices, and vice versa. Common elements between the RAN system 900 in FIG. 9 and the RAN system 1000 in FIG. 10 are shown with common element numbers.

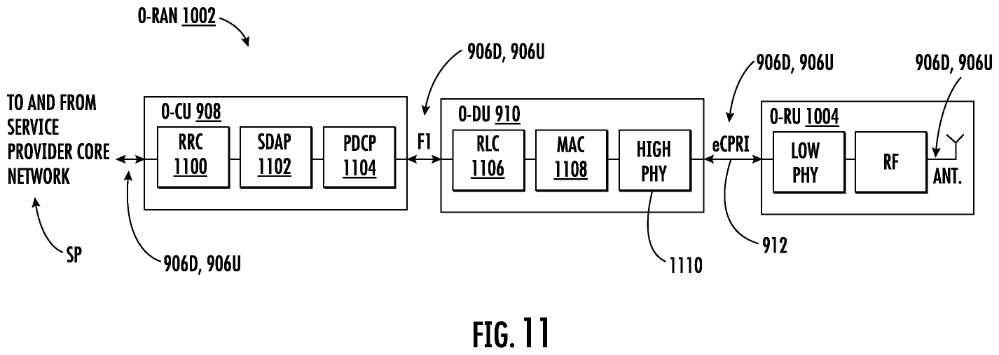

FIG. 11 is a schematic diagram of exemplary division of components and communications layers between devices in the O-RANs 1002(1)-1002(N) in FIG. 10. In this regard, the functionality of the base station (gNB, as called in the context of 5G) of the O-RAN 1002 is divided into three functional units of the O-CU 908, the O-DU 910, and the O-RU 1004 that may run on different hardware platforms and reside at different locations. The O-RU 1004 includes the lowest layers of the base station, and it is the entity that wirelessly transmits the downlink communications signals 906D and receives the uplink communications signals 906U. The O-CU 908 includes the highest layers of the base and is coupled to the “Core Network” of the cellular service provider SP. The O-CU 908 hosts a handful of protocols, which are the radio resource control (RRC) 1100, service data adaptation protocol (SDAP) 1102, and packet data convergence protocol (PDCP) 1104. The O-DU 910 includes the middle layers of the base station. The O-DU 910 hosts another set of protocols, which are the radio link control (RLC) protocol 1106, medium access control (MAC) protocol 1108, and the physical interface (PHY) 1110. The F1 interface connects the O-CU 908 and the O-DU 910. The eCPRI/O-RAN Fronthaul interface 912 connects the O-DU 910 and the O-RU 1004. The F1 and eCPRI/O-RAN Fronthaul interfaces F1, 912 can use Ethernet protocol for conveying the data in the downlink and uplink communications signals 906D, 906U between the units. The O-RU 1004 processes radio frequencies received by the physical layer of the network PHY within RF circuits 1112.

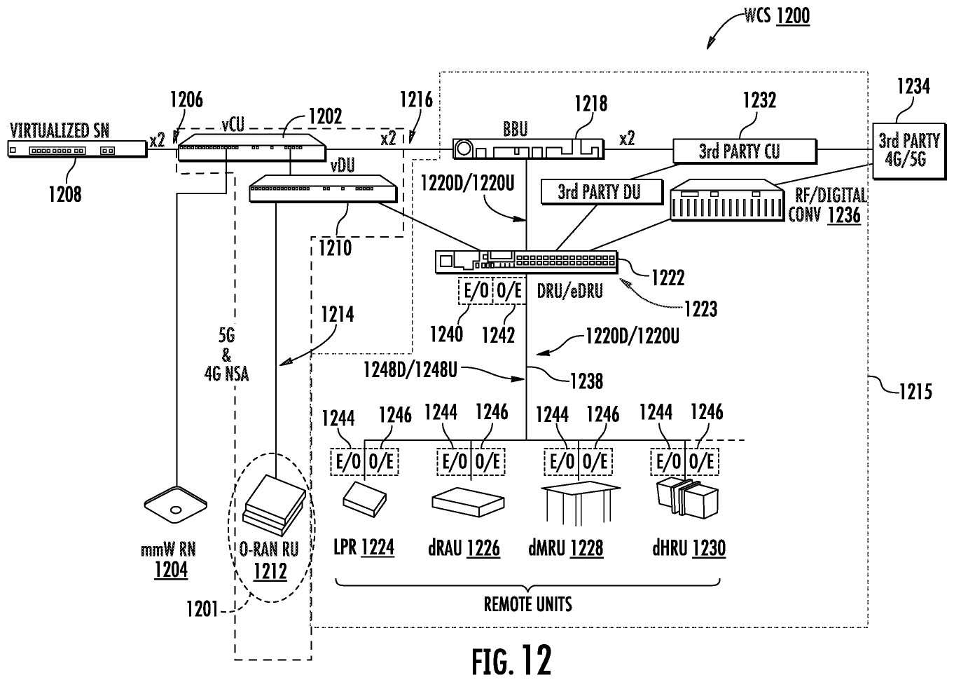

FIG. 12 is a schematic diagram of an exemplary WCS 1200 that can include one or RAN systems implemented according to a RAN standard (e.g., O-RAN standard), including but not limited to the RAN subsystems 104, 152, and each configured to transparently interface with shared RU(s) through an intermediary neutral host agent device according to any of the embodiments disclosed herein. The WCS 1200 supports both legacy 4G LTE, 4G/5G non-standalone (NSA), and 5G standalone communications systems. As shown in FIG. 12, a centralized services node 1202 (which can be a CU described above) is provided that is configured to interface with a core network to exchange communications data and distribute the communications data as radio signals to remote units, which can be the RUs described above. In this example, the centralized services node 1202 is configured to support distributed communications services to a mmWave radio node 1204. The mmWave radio node 1204 is an example of a wireless device that can be configured to selectively control whether received transmit channels are transmitted through an antenna array. Although only one mmWave radio node 1204 is shown in FIG. 12, it should be appreciated that the WCS 1200 can be configured to include additional mmWave radio nodes 1204, as needed. The functions of the centralized services node 1202 can be virtualized through an x2 interface 1206 to another services node 1208. The centralized services node 1202 can also include one or more internal radio nodes that are configured to be interfaced with a DU 1210 (which can be a virtual DU and/or a DU described above) to distribute communications signals (e.g., communications channels) to one or more O-RAN RUs 1212 that are configured to be communicatively coupled through an O-RAN interface 1214. The O-RAN RUs 1212 are another example of a wireless device that can be configured to selectively control whether received transmit channels are transmitted through an antenna array. The O-RAN RUs 1212 are each configured to communicate downlink and uplink communications signals in the coverage cell(s) 1201.

The centralized services node 1202 can also be interfaced with a DCS 1215 through an x2 interface 1216. Specifically, the centralized services node 1202 can be interfaced with a digital baseband unit (BBU) 1218 in the DCS that can provide a digital signal source to the centralized services node 1202. The digital BBU 1218 may be configured to provide a signal source to the centralized services node 1202 to provide electrical downlink communications signals 1220D (electrical downlink communications signals 1220D can include downlink channels) to a digital routing unit (DRU) 1222 as part of a digital DAS. The digital BBU 1218 may be configured to include a neutral host agent 1223. The DRU 1226 is configured to split and distribute the electrical downlink communications signals 1220D to different types of remote wireless devices, including a low-power remote unit (LPR) 1224, a radio antenna unit (dRAU) 1226, a mid-power remote unit (dMRU) 1228, and/or a high-power remote unit (dHRU) 1230. The DRU 1222 is also configured to combine electrical uplink communications signals 1220U (electrical uplink communications signals 1220U can include uplink channels) received from the LPR 1224, the dRAU 1226, the dMRU 1228, and/or the dHRU 1230 and provide the combined electrical uplink communications signals 1220U to the digital BBU 1218. The digital BBU 1218 is also configured to interface with a third-party central unit 1232 and/or an analog source 1234 through a radio frequency (RF)/digital converter 1236.

The DRU 1222 may be coupled to the LPR 1224, the dRAU 1226, the dMRU 1228, and/or the dHRU 1230 via an optical fiber-based communication medium 1238. In this regard, the DRU 1222 can include a respective electrical-to-optical (E/O) converter 1240, and a respective optical-to-electrical (O/E) converter 1242. Likewise, each of the LPR 1224, the dRAU 1226, the dMRU 1228, and the dHRU 1230 can include a respective E/O converter 1244 and a respective O/E converter 1246.

The E/O converter 1240 at the DRU 1222 is configured to convert the electrical downlink communications signals 1220D into optical downlink communications signals 1220D for distribution to the LPR 1224, the dRAU 1226, the dMRU 1228, and/or the dHRU 1230 via the optical fiber-based communications medium 1242. The O/E converter 1250 at each of the LPR 1224, the dRAU 1226, the dMRU 1228, and/or the dHRU 1230 is configured to convert the optical downlink communications signals 1220D back to the electrical downlink communications signals 1220D. The E/O converter 1244 at each of the LPR 1224, the dRAU 1226, the dMRU 1228, and the dHRU 1230 is configured to convert the electrical uplink communications signals 1220U into optical uplink communications signals 1220U. The O/E converter 1242 at the DRU 1222 is configured to convert the optical uplink communications signals 1220U back to the electrical uplink communications signals 1220U.

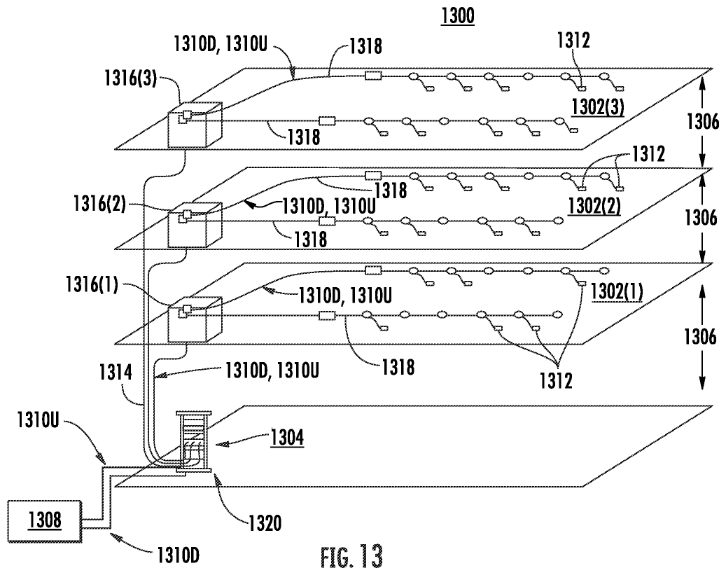

FIG. 13 is a partial schematic cut-away diagram of an exemplary building infrastructure 1300 that includes an exemplary RAN system 1302, including but not limited to the RAN subsystems 104, 152, wherein the RAN system 1302 includes multiple RANs 1304 implemented according to a RAN standard (e.g., O-RAN standard) and each configured to transparently interface with shared RUs through an intermediary neutral host agent device. The building infrastructure 1300 in this embodiment includes a first (ground) floor 1302(1), a second floor 1302(2), and a third floor 1302(3). The floors 1302(1)-1302(3) are serviced by one or more RANs 1304 to provide antenna coverage areas 1306 in the building infrastructure 1300. The RANs 1304 are communicatively coupled to a core network 1308 to receive downlink communications signals 1310D (downlink communications signals 1310D can include downlink channels) from the core network 1308. The RANs 1304 are communicatively coupled to a respective plurality of RUs 1312 to distribute the downlink communications signals 1310D to the RUs 1312 and to receive uplink communications signals 1310U (uplink communications signals 1310U can include uplink channels) from the RUs 1312, as previously discussed above. Any RU 1312 can be shared by any of the multiple RANs 1304. A neutral host agent 1320 may be provided.

The downlink communications signals 1310D and the uplink communications signals 1310U communicated between the RANs 1304 and the RUs 1312 are carried over a riser cable 1314. The riser cable 1314 may be routed through interconnect units (ICUs) 1316(1)-1316(3) dedicated to each of the floors 1302(1)-1302(3) that route the downlink communications signals 1310D and the uplink communications signals 1310U to the RUs 1312 and also provide power to the RUs 1312 via array cables 1318.

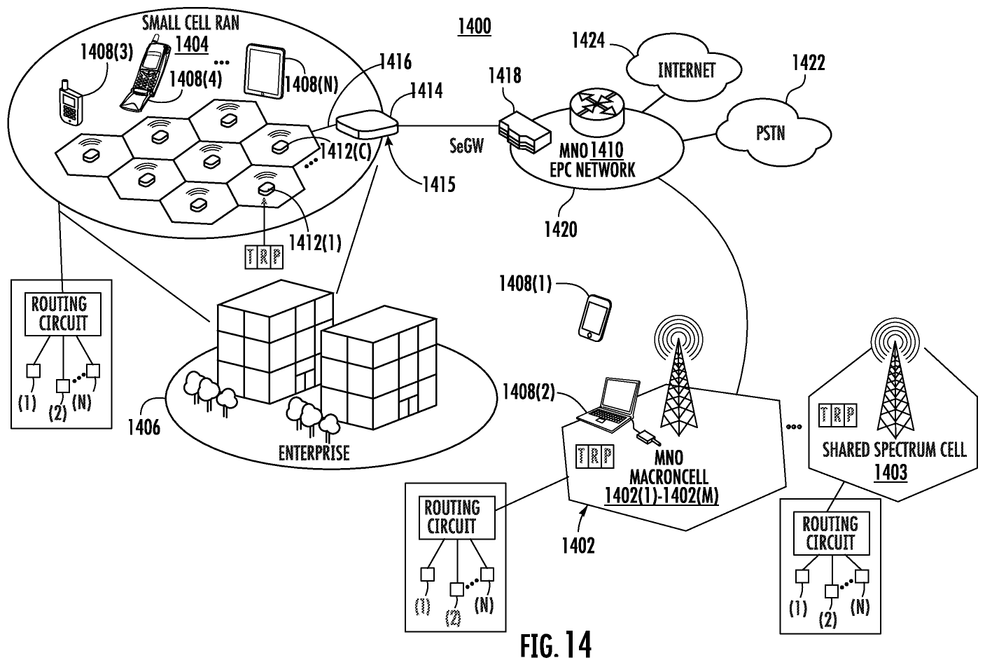

FIG. 14 is a schematic diagram of an exemplary mobile telecommunications RAN system 1400 (also referred to as “RAN system 1400”) that can include but is not limited to, the RAN subsystems 104, 152 wherein the RAN system 1400 includes multiple RANs implemented according to a RAN standard (e.g., O-RAN standard) and each configured to transparently interface with shared RUs through an intermediary neutral host agent device.

In this regard, RAN system 1400 includes exemplary macrocell RANs 1402(1)-1402(M) (“macrocells 1402(1)-1402(M)”) and an exemplary small cell RAN 1404 located within an enterprise environment 1406 and configured to service mobile communications between a user mobile communications device 1408(1)-1408(N) to a mobile network operator (MNO) 1410. A serving RAN for the user mobile communications devices 1408(1)-1408(N) is a RAN or cell in the RAN in which the user mobile communications devices 1408(1)-1408(N) have an established communications session with the exchange of mobile communications signals for mobile communications. Thus, a serving RAN may also be referred to herein as a serving cell. For example, the user mobile communications devices 1408(3)-1408(N) in FIG. 14 are being serviced by the small cell RAN 1404, whereas the user mobile communications devices 1408(1) and 1408(2) are being serviced by the macrocell 1402. The macrocell 1402 is an MNO macrocell in this example. The macrocell 1402 can be or include a wireless device(s) that can be configured to selectively control whether received transmit channels are transmitted through an antenna array of the wireless device. However, a shared spectrum RAN 1403 (also referred to as “shared spectrum cell 1403”) includes a macrocell in this example and supports communications on frequencies that are not solely licensed to a particular MNO, such as CBRS for example, and thus may service user mobile communications devices 1408(1)-1408(N) independent of a particular MNO. The macrocell 1402 can be or include a wireless device(s) that can be configured to selectively control whether received transmit channels are transmitted through an antenna array of the wireless device. The macrocell 1402 can be a wireless device that can be configured to selectively control whether received transmit channels are transmitted through an antenna array of the wireless device. For example, the shared spectrum cell 1403 may be operated by a third party that is not an MNO, wherein the shared spectrum cell 1403 supports CBRS. The MNO macrocell 1402, the shared spectrum cell 1403, and the small cell RAN 1404 may be neighboring radio access systems to each other, meaning that some or all can be in proximity to each other such that a user mobile communications device 1408(3)-1408(N) may be able to be in communications range of two or more of the MNO microcell(s) 1402, the shared spectrum cell 1403, and the small cell RAN 1404 depending on the location of the user mobile communications devices 1408(3)-1408(N).

The RAN system 1400 includes the enterprise environment 1406 in which the small cell RAN 1404 is implemented. The small cell RAN 1404 includes a plurality of small cell radio nodes 1412(1)-1412(C), which are wireless devices that can be configured to selectively control whether received transmit channels are transmitted through an antenna array of the wireless devices. Each small cell radio node 1412(1)-1412(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 14, the small cell RAN 1404 includes one or more service nodes (represented as a single services node 1414) that manage and control the small cell radio nodes 1412(1)-1412(C). In alternative implementations, the management and control functionality may be incorporated into a radio node, distributed among nodes, or implemented remotely (i.e., using infrastructure external to the small cell RAN 1404). The small cell radio nodes 1412(1)-1412(C) are coupled to the services node 1414 over a direct or local area network (LAN) connection 1416 as an example, typically using secure IPsec tunnels. The small cell radio nodes 1412(1)-1412(C) can include multi-operator radio nodes. A neutral host agent device 1415 could be provided between the services node 1414 and the small cell radio nodes 1412(1)-1412(C) to transparently manage communications between the services node 1414 and shared small cell radio nodes 1412(1)-1412(C). The services node 1414 aggregates voice and data traffic from the small cell radio nodes 1412(1)-1412(C) and provides connectivity over an IPsec tunnel to a security gateway (SeGW) 1418 in a network 1420 (e.g., evolved packet core (EPC) network in a 4G network, or 5G Core in a 5G network) of the MNO 1410. The network 1420 is typically configured to communicate with a public switched telephone network (PSTN) 1422 to carry circuit-switched traffic, as well as for communicating with an external packet-switched network such as the Internet 1424.

The RAN system 1400 also generally includes a node (e.g., eNodeB or gNodeB) base station, or “macrocell” 1402. The radio coverage area of the macrocell 1402 is typically much larger than that of a small cell, where the extent of coverage often depends on the base station configuration and the surrounding geography. Thus, a given user mobile communications device 1408(3)-1408(N) may achieve connectivity to the network 1420 (e.g., EPC network in a 4G network or 5G Core in a 5G network) through either a macrocell 1402 or small cell radio node 1412(1)-1412(C) in the small cell RAN 1404 in the RAN system 1400.

Many of the elements of the WCS can include a computer system 1500, such as that shown in FIG. 15, to carry out their functions and operations. With reference to FIG. 15, the computer system 1500 includes a set of instructions for causing the multi-operator radio node component(s) to provide its designed functionality and the circuits discussed above. The multi-operator radio node component(s) may be connected (e.g., networked) to other machines in a LAN, an intranet, an extranet, or the Internet. The multi-operator radio node component(s) may operate in a client-server network environment or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1500 in this embodiment includes a processing circuit or processor 1502(which may be, for example, the control circuit of the CSC 910), a main memory 1504 (e.g., read-only memory (ROM), flash memory, dynamic random access memory (DRAM) such as synchronous DRAM (SDRAM), etc.), and a static memory 1506 (e.g., flash memory, static random access memory (SRAM), etc.), which may communicate with each other via a data bus 1508. Alternatively, the processing circuit 1502 may be connected to the main memory 1504 and/or static memory 1506 directly or via some other connectivity means. The processing circuit 1502 may be a controller, and the main memory 1504 or static memory 1506 may be any type of memory.

The processing circuit 1502 represents one or more general-purpose processing circuits such as a microprocessor, central processing unit, or the like. More particularly, the processing circuit 1502 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1502 is configured to execute processing logic in instructions 1516 for performing the operations and steps discussed herein.

The computer system 1500 may further include a network interface device 1510. The computer system 1500 also may or may not include an input 1512 to receive input and selections to be communicated to the computer system 1500 when executing instructions 1516. The computer system 1500 also may or may not include an output 1514, including, but not limited to, a display, a video display unit (e.g., a liquid crystal display (LCD) or a cathode ray tube (CRT)), an alphanumeric input device (e.g., a keyboard), and/or a cursor control device (e.g., a mouse).

The computer system 1500 may or may not include a data storage device that includes instructions 1516 stored in a computer-readable medium 1518. The instructions 1516 may also reside, completely or at least partially, within the main memory 1504 and/or within the processing circuit 1502 during execution thereof by the computer system 1500, the main memory 1504, and the processing circuit 1502 also constituting the computer-readable medium 1518. The instructions 1516 may further be transmitted or received over a network 1520 via the network interface device 1510.

While the computer-readable medium 1518 is shown in an exemplary embodiment to be a single medium, the term “computer-readable medium” should be taken to include a single medium or multiple media (e.g., a centralized or distributed database and/or associated caches and servers) that store the one or more sets of instructions 1516. The term “computer-readable medium” shall also be taken to include any medium that is capable of storing, encoding, or carrying a set of instructions for execution by the processing circuit and that causes the processing circuit to perform any one or more of the methodologies of the embodiments disclosed herein. The term “computer-readable medium” shall accordingly be taken to include, but not be limited to, solid-state memories, optical and magnetic medium, and carrier wave signals.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product or software that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read-only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware and may reside, for example, in Random Access Memory (RAM), flash memory, Read-Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modification combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. An enhanced NodeB (eNB) comprising:
a first interface configured to communicate with user equipment (UE); and
a control circuit coupled to the first interface, the control circuit configured to:
receive B1 reports from UE;
determine that a handover between cells is appropriate based on the B1 reports; and
initiate handover of the user equipment from a first cell to a second cell.

2. The eNB of claim 1, wherein the control circuit is further configured to communicate with an originating gNB as part of the handover.

3. The eNB of claim 2, wherein the control circuit is further configured to communicate with a target gNB as part of the handover.

4. The eNB of claim 3, wherein the originating gNB is the target gNB.

5. The eNB of claim 3, wherein the originating gNB is different than the target gNB.

6. The eNB of claim 1, where the control circuit is configured to configure the user equipment to provide B1 reports.

7. The eNB of claim 6, wherein the control circuit is further configured to set a threshold for the UE, wherein the threshold is used by the UE to determine whether to generate a B1 report.

8. The eNB of claim 1, further comprising a second interface configured to communicate with a core subsystem.

9. The eNB of claim 8, wherein the second interface is configured to operate according to a 4G cellular protocol.

10. The eNB of claim 1, wherein the B1 report contains a signal strength indication.

11. A method of controlling handovers, comprising:
at an enhanced nodeB (eNB), receiving B1 reports from user equipment (UE);
determining, at the eNB, that a handover between cells is appropriate based on the B1 reports; and
initiating handover of the UE from a first cell to a second cell.

12. The method of claim 11, further comprising configuring B1 thresholds for the UE.

13. The method of claim 11, further comprising configuring the UE to report B1 readings to the eNB.

14. The method of claim 11, wherein receiving B1 reports comprises receiving signal strength indications in the B1 reports.

15. The method of claim 11, wherein initiating handover comprises communicating with an originating gNB.

16. The method of claim 15, wherein initiating handover further comprises communicating with a target gNB.

17. The method of claim 16, wherein the originating gNB is the target gNB.

18. The method of claim 16, wherein the originating gNB and the target gNB are different devices.
